(19) United States
(12) Patent Application Publication
(10) Pub. No.: US 2006/0071751 A1
(43) Pub. Date: Apr. 6, 2006

(54) Switch

(75) Inventors: Philippa C Wagner, London (GB); Katharine Pulford, London (GB)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., NL-5621 BA EINDHOVEN (NL)

(21) Appl. No.: 10/512,618

(22) PCT Filed: Apr. 23, 2003
(86) PCT No.: PCT/IB03/01699

§ 371 Date: Oct. 26, 2004

(30) Foreign Application Priority Data
Apr. 30, 2002 (GB) 0209888.7

(51) Int. Cl. H01C 10/10

(52) U.S. Cl. 338/47

(57) ABSTRACT

A woven fabric switch is provided comprising a woven fabric (41) which divides to form a first layer (44) and a second layer (45) ordinarily spaced apart from each other. The size of the first layer (44) in terms of length between first and second boundary (50), (51) is greater than the size of the second layer (45) in terms of its length spanning between first and second boundary (50), (51), causing the first layer (44) to deform in the z direction and ordinarily maintain the first layer (44) and second layer (45) spaced apart from each other and so serving to define the void (46). A plurality of conductive elements (47) of the first layer (44) are physically separated from the plurality of conductive elements (48) of the second layer (45) and the switch is in an electrically off state. Application of a resilient force to deform first layer (44) causes the plurality of conductive elements (47) of the first layer (44) to be brought into contact with the plurality of conductive elements (48) of the second layer (45) and the switch is now in an electrically on state.

The present invention relates to a switching arrangement that is particularly, but not exclusively, suitable for use within flexible articles such as apparel and soft furnishings.

The task of integrating or fitting electrical and electronic apparatus within clothing or other soft items presents a number of problems to the designer. The example of incorporation of switches is no exception.

One approach to integrating electrical switches into clothing is to use standard “off the shelf” electronic components that are then sewn, glued or otherwise mounted to clothing. Unfortunately this approach has a number of disadvantages arising from the fact that these components are primarily intended for use in conventional electronic equipment. In such conventional equipment these switches are easily accommodated by mounting them on a printed circuit board or other part of the equipment. However, in the case of clothing and furnishing which is normally manufactured from flexible textile material, even if the switches are successfully attached, the mounting achieved will not always be rigid making operation of the switch difficult, especially one-handed operation. Taking the example of a known simple toggle switch, the base part of the switch needs to be held firmly while the lever part is operated. While the unsatisfactory physical mounting of the switch causes problems with switch operation, another drawback is that clothing provided with these components has the feel and appearance of clothing or furnishing with components stuck on top, rather than the components being neatly integrated and in keeping with the character of the items to which they are attached.

This latter point is important because a primary consideration when selecting a garment or article of furnishing is its appearance. The inclusion of a switch that detracts from the appeal of clothing or other article is most undesirable from the point of view of the designer and consumer. Switches for use in clothing or furnishing that are to be visible should look right, whether they are incorporated as a prominent design feature, as a discrete implementation or even disguised. In many cases there is a requirement for the component to have a degree of mechanical flexibility so that it is able to conform to some extent to the shape of the article to which it is applied or integrated. In the cases where the article is flexible, it may be desirable that, the component is able to flex with that article. Traditional electronic components do not always meet this requirement.

The use of such conventional components also causes problems to manufacturers because, the machines and processes commonly used within the garment or furniture construction industry will not be designed for connecting the switches to fabrics, either in terms of providing a physical mounting for the switches or making the electrical connections thereto.

One known approach to providing a switch constructed from fabric is discussed in EP-A-0 989 509. Two electrically conductive fabric planes are separated from each other by an electrically insulating mesh. When a force is applied to one of the planes, the two conducting planes may be brought together, through the mesh, thereby providing electrical continuity between the conducting planes. This three layer structure needs to be produced which has the potential to ultimately limit the flexibility of switches based on this structure and increase the profile of such switches. In the case where the structure is produced by attaching together three layers, the need to perform the attaching operation has the potential to add to production costs. WO-A-00/72239 notes that the structure described by EP-A-0 989 509 can sometimes suffer inadvertent operation when the structure is folded because the two electrically conductive fabric planes can be forced together through the mesh in the vicinity of the fold. In order to address the problem of such inadvertent operation WO-A-00/72239 proposes a five layer structure comprising two electrically conductive woven outer fabric layers separated by an electrically conductive knitted central layer and two intermediate electrically insulating ‘mesh’ layers of warp knit construction; one mesh layer being located between each of the conductive outer fabric layers and the central layer. On suitable application of pressure the two electrically conductive outer fabric layers make contact through apertures in the insulating mesh with the central conductive layer, the central layer providing a conductive path between the outer conductive fabric layers. This five layer structure needs to be produced which has the potential to ultimately limit the flexibility of switches based on this structure and increase the profile of such switches. In the case where the structure is produced by attaching together five layers, the need to provide five layers and perform the attaching operation has the potential to add to production costs.

It is an object of the present invention to provide an electrical switch which may be integrated into clothing, soft furnishings and the like.

In accordance with the present invention there is provided a textile switch comprising a woven structure having at least one switch region where the woven structure divides to exhibit a first layer and a second layer ordinarily spaced apart from each other, wherein on application of force at least one of the first and second layers is movable towards the other one of the second and first layer, respectively, to cause actuation of the switch. Thus the entire switch may be produced as a woven structure, optionally within a single weaving operation. Such a switch, especially where it is of single cloth construction, may have a low cost of production, be of a low profile and be produced in a large number configurations simply by changing the pattern of the weave structure. Such a woven switch has the potential to provide a high degree of mechanical flexibility.

Optionally, at least one of the first layer and the second layer include one or more electrically conductive element to form switch contact portions. The first layer or the second layer of the switch region may be formed exclusively of such electrically conductive elements, or of a combination of electrically conductive elements and electrically insulative elements. By application of the appropriate force to cause the at least one of the first and second layer to move towards the other one of the second and first layer, respectively, electrically conductive elements of the first layer are able to establish physical and electrical contact with electrically conductive elements of the second layer, thereby closing the switch.

Optionally, at least one of the first layer and the second layer include one or more electrically conductive element to form electrodes of a capacitor. In this arrangement, by application of the appropriate force to cause the at least one of the first and second layer to move towards the other one of the second and first layer, respectively, a capacitor plate formed by the first layer can be caused to move towards a capacitor plate formed by the second layer, thereby reducing the separation between the two plates. The separation between the plates affects the value of a capacitor formed by the two plates and measurements of this capacitance may be observed to establish whether the switch has been actuated.

Optionally, at least one of the first layer and the second layer include one or more fibre optic element. Application of a force to cause the at least one of the first and second layer to move towards the other one of the second and first layer, respectively, can resiliently deform the layer which includes the one or more optical fibre element thus causing alteration in the leakage of light from the or each optical element. The occurrence of such leakage may be detected and the degree of leakage then be used as a factor to indicate actuation of the switch.

Optionally, the first and second layer of the textile switch are ordinarily spaced apart by virtue of one of the first or second layer being of greater size than the other one of the second or first layer within the switching region.

Optionally, the first and second layer of the textile switch are ordinarily spaced apart by virtue of at least one of the first or second layer being fabricated to adopt a non-linear profile.

These and other aspects and optional features of the present invention appear in the appended claims to which the reader is now referred and which are incorporated herein by reference.

The present invention will now be described, by way of example only, with reference to the Figures of the accompanying drawings wherein:

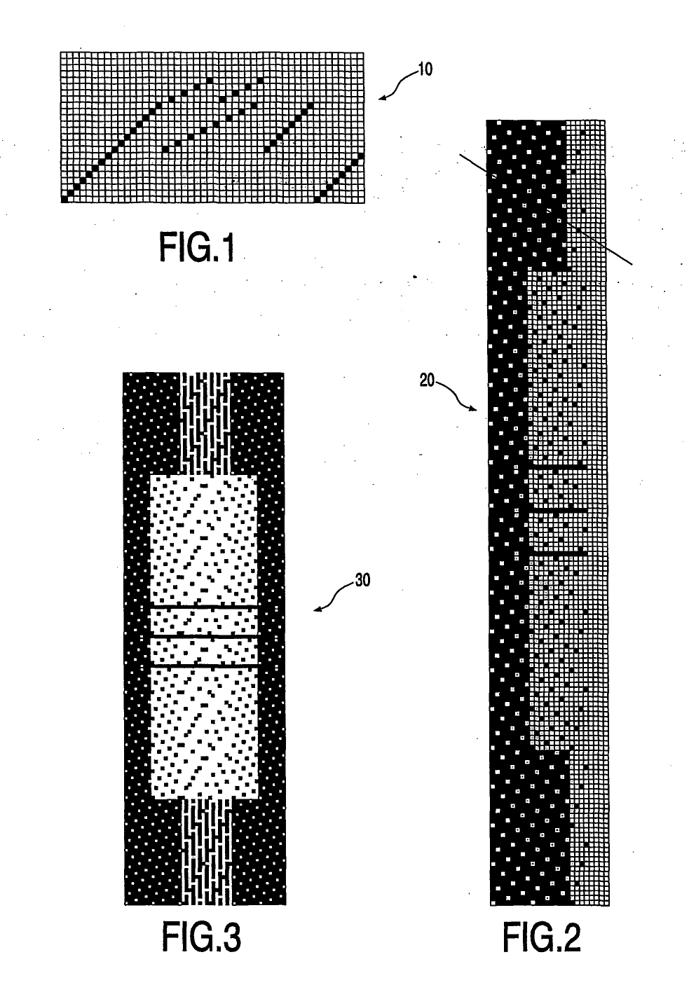

FIG. 1 shows a block threading plan for weaving a first embodiment of the present invention;

FIG. 2 shows a peg plan for weaving a first embodiment of the present invention;

FIG. 3 shows a composition diagram for a first embodiment of the present invention;

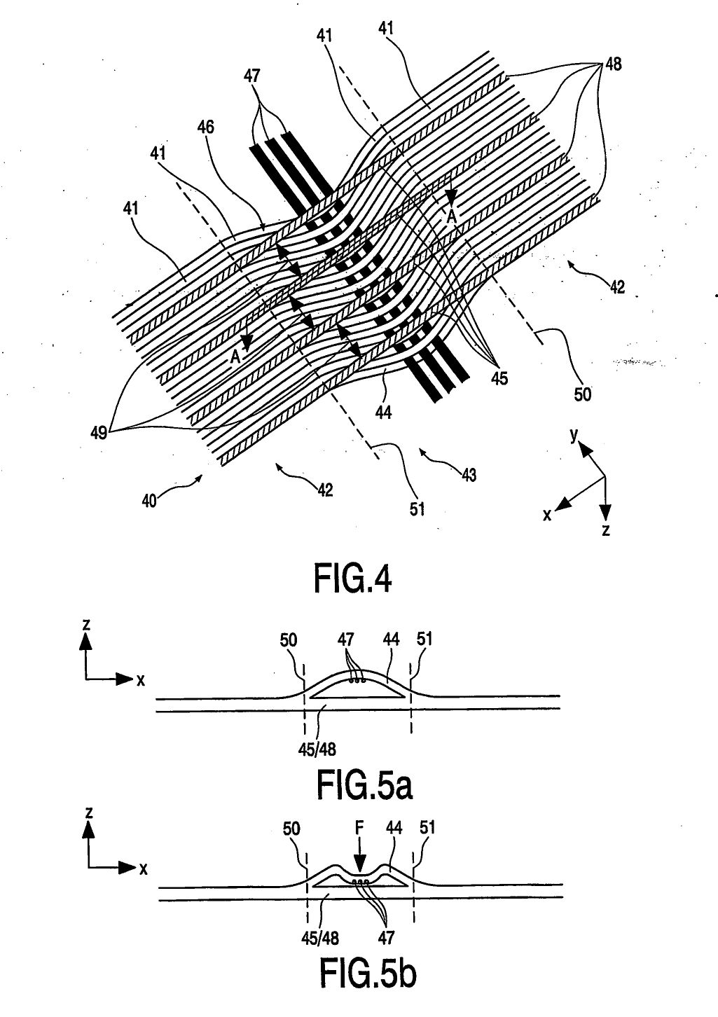

FIG. 4 shows an underside perspective view of a first embodiment of a switch of the present invention;

FIG. 5a shows a partial cross sectional view taken along line A-A of FIG. 4 of the first embodiment switch in a first configuration;

FIG. 5b shows a partial cross sectional view of the first embodiment switch in a second configuration;

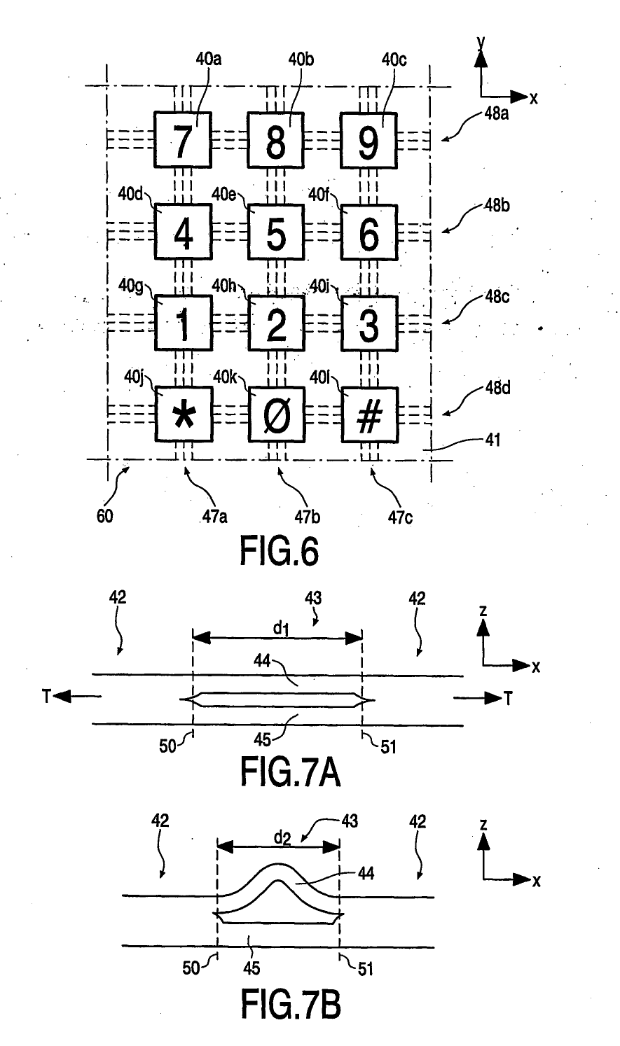

FIG. 6 shows a plan view of a fabric keypad made in accordance with the present invention and comprising twelve first embodiment switches;

FIG. 7a shows a partial cross sectional view of elements of a weave for producing the first embodiment switch while held in a weaving loom during manufacture; and

FIG. 7b shows a partial cross sectional view of the weave of FIG. 7a after removal from the weaving loom and formed to produce a switch.

It should be noted that the drawings are diagrammatic and not drawn to scale. Relative dimensions and proportions of parts of the Figures have been shown exaggerated or reduced in size for the sake of clarity and convenience in the drawings. The same reference signs are generally used to refer to corresponding or similar features in the different embodiments.

The block threading plan 10 of FIG. 1 is for 20 shafts and will be understood by the person skilled in the art as indicating required set-up aspects of a weaving loom for the purpose of weaving the switch of the first embodiment of the present invention. The peg plan 20 of FIG. 2 is applicable to the weaving of the switch of the first embodiment of the present invention. The composition diagram 30 illustrated in FIG. 3 is applicable to the switch of the first embodiment of the present invention.

Referring to FIG. 4, a switch 40 is constructed of a woven fabric 41. The fabric 41 is generally made of electrically insulative material and comprises a number of portions including one or more switch border region 42 and one or more switch region 43. Within the or each switch region 43 the woven fabric 41 divides to form a first layer 44 and a second layer 45. The division of the layers forms a void 46 in the fabric weave between the first layer 44 and second layer 45 which is typically occupied by air. The first layer 44 is provided with a plurality of electrically conductive elements 47 located to face the second layer 45. The plurality of conductive elements 47 of the first layer form the first switch contact. The second layer 45 is provided with a plurality of electrically conductive elements 48 located to face the first layer 44. Therefore, the conductive elements 47 of the first layer face the conductive elements 48 of the second layer. The plurality of conductive elements 48 of the second layer form the second switch contact. In the case of the second layer 45, the plurality of electrically conductive elements 48 are spaced apart by relatively large gaps 49 although this is optional; the gaps could be populated with further conductive elements 48, an alternative form of conductive elements, insulating elements or any suitable combination thereof.

In the described example switch, the woven fabric 41 divides to form the first layer 44 and second layer 45 at locations falling on a first boundary 50 and second boundary 51 of the border regions 42 and the switch region 43. The boundaries 50, 51 are shown as broken lines in the Figures. The first and second layers are fastened to each other at these boundary locations by virtue of the weave process. Optionally, this fastening may be reinforced, for example by stitching. Viewing the cross section of the switch, in particular with reference to FIG. 5a, it will be noted that the size of the first layer 44 in terms of its length spanning between first and second boundaries 50 and 51 is greater than the size of the second layer 45 in terms of its length spanning between first and second boundaries 50 and 51. Because the first layer 44 and second layer 45 are attached to each other at boundaries 50 and 51 by virtue of the weave process and because the length of the first layer 44 spanning between boundaries 50 and 51 is greater than the corresponding length of the second layer 45 spanning between boundaries 50 and 51, the first layer 44 is caused to deform in the z direction and hence create a bulge or ‘blister’ within switch region 43 when compared with border regions 42 of the weave 41. Therefore this tendency to adopt a bulge ordinarily keeps the first layer 44 and second layer 45 spaced apart from each other and so serving to define the void 46. In this first condition the plurality of conductive elements 47 of the first layer 44 are physically separated from the plurality of conductive elements 48 of the second layer 45 and the switch is in an ‘off’ or electrically ‘open’ state.

Application of a sufficient force, indicated as ‘F’ in FIG. 5b, causes resilient deformation of the first layer 44 causing it to be moved towards the second layer 45 and thus bringing the plurality of conductive elements 47 of the first layer 44 into contact with the plurality of conductive elements 48 of the second layer 45. In this second condition, electrical continuity is established between the plurality of conductive elements 47 and 48 with the result that the switch is now in an ‘on’ or electrically ‘closed’ state.

Removal of the force ‘F’ allows the first layer 44 to resiliently move away from the second layer 45 and the switch resumes the first condition in which it is electrically ‘open’.

Turning to the constructional aspects of the woven switch, in the figures of the drawings the warp of the woven material is shown in the y direction and the weft of the woven material is shown in the x direction. In the case of the illustrated first embodiment switch 40, the woven switch is produced with a weave structure such that yarns in the warp direction are of nylon monofilament and yarns in the weft direction are 2-60's cotton. The person skilled in the art will appreciate that nylon and cotton in their usual form are electrically insulating materials. The weave is supplemented in selected regions of the warp by a plurality of electrically conductive yarns of silver coated polyamide. These further warp yarns are provided within the first layer 44 in the vicinity of the switch regions 43; these further yarns form the plurality of electrically conductive elements 47 of the first layer 44. The weave is further supplemented in the weft by yarns composed of a combination of an elastaine (for example Lycra®) and stainless steel mix or equally any other such stretch conductor. These further supplemental weft yarns are present in switch border regions 42 of the fabric 41 but extend within the switch region 43 from first boundary 50 to second boundary 51 to form the plurality of conductive elements 48 of the second layer 45. Elastaine is resiliently extendible in its lengthways direction. It will be appreciated by the person skilled in the art that stainless steel is electrically conductive.

The switch may have further yarn in the warp or the weft for reasons of aesthetics or technical advantage. For example, a different colour yarn or icon may be woven in the switch region 43 to distinguish it from the border regions 42 and so providing an indication to a user of where to press the fabric to actuate the switch. Provision of an icon in the switch region 43 can serve to indicate to a user the function of the switch.

With reference to FIG. 6, a fabric keypad 60 is shown having twelve first embodiment switches, denoted here as 40a, 40b, . . . 40l. Switches aligned in the ‘y’ direction share common conductive warp yarns. For example, switches 40a, 40d, 40g and 40j share the same warp yarns denoted as 47a. Also shown for other switches are common conductive warp yarns 47b and 47c. Switches aligned in the ‘x’ direction share common conductive weft yarns. For example, switches 40a, 40b and 40c share the same conductive weft yarns, denoted here as 48a. Also shown are common conductive weft yarns 48a, 48b and 48c. Common conductive warp and weft yarns are shown as broken lines in FIG. 6.

Electrical connections can be made with each of the groups of common conductive warp yarns 47a, 47b 47c and common conductive weft yarns 48a, 48b, 48c and 48d to establish if any of the switches 40a to 40l have been actuated. Matrix addressing schemes may be employed to scan columns formed by conductive warp yarns 47a, 47b 47c and rows formed by conductive weft yarns 48a, 48b, 48c, 48d as will be appreciated by the person skilled in the art.

It will be noted that the switches are shown carrying a numeral or other character or icon indicate to a user the function of that switch. Such a character or icon may be formed by the weave pattern itself. The weave pattern may be altered to show a character or icon of choice, such as numerals or letters of the alphabet.

In a first method for producing the switch of the first embodiment (or a keypad of such switches), the yarns in the warp and weft are held under tension during the weaving process. This has the result that the combined elastaine and stainless steel weft yarns (which are resiliently extendible) are formed in the weave while they are stretched and so extended in their lengthways direction to virtually their full extent. In the border regions 42 these weft yarns are woven in tightly with the warp yarn, so on removing the woven fabric from the loom, tightly packed warp fibres prevent the elastaine and cotton mix weft yarns from contracting within the border regions 42. A portion of the weave so held under tension in the weft-wise direction is shown in FIG. 7a.

However, in the switch region 43, the elastaine and stainless steel mix weft yarns are not woven with any warp yarns, so on removing the woven fabric from the loom, these portions of weft yarn contract to assume a reduction in length so as to result in the second layer 45 (formed of weft yarns) of the switch becoming shorter than the first layer 44, thus forcing the first layer to bulge out, as shown in FIG. 7b.

In a second method for producing the switch of the first embodiment (or keypad of such switches), the yarns in the warp and weft are woven to produce the border regions 42 and switch region or regions 43 having first layer 44 and second layer 45, in a similar manner to that described above in the first method for producing the switch. However, in this case the weft yarn 48 of the second layer 45 is replaced by a retractable yarn. Retractable yarn is not resiliently extendible, but through suitable treatment it can be made to permanently retract in its lengthways direction. Again, a portion of the weft is shown diagrammatically in FIG. 7a. After removal from the loom, the switch regions are treated so that the weft yarn of the second layer 45 of the switch contracts to assume a reduction in length so as to form the second layer 45 of the switch, shorter than the first layer 44, thus forcing the first layer to bulge out, as shown diagrammatically in FIG. 7b. It would be possible for the second layer 45 to also include elastaine yarns. At least the retractable yarn and/or elastaine yarns must be provided with an electrically conductive quality and this may be done by mixing in conductive materials such as stainless steel (as already mentioned) or providing an elastaine or retractable yarn of material having inherent electrically conductive qualities.

A variety of such retractable yarns exist. One example is cotton yarn which retracts when treated with a caustic solution; this effect is exploited when making seersucker fabric. Another example is that of is that of false twist textured yarn, which may be mixed with conductive filaments; such yarn grows in diameter but reduces in length if subject to application of steam. Acrylic based retractable yarn is available. A form of resiliently extendible yarn is Dupont bi-component yarn that, on suitable treatment, through the varying shrink rate of each polymer making up the yarn creates a coil effect to form a helix along the axial length of the yarn which in return allows natural stretch in a textile.

The exact choice of yarn or yarns employed in the warp and weft, and also the count and set of the yarn/yarns may be varied depending on the required properties of the switch. For example, the fibres or yarns may be monofilament, multifilament or cut staple yarns. Monofilament yarns, multifilament yarns or selected fibres of multifilament yarns may be coated with electrically conductive or electrically insulative materials. Further example yarns may be produced by drawing continuous metal filament or cut staple fibres may be carded and spun. If yarns are multifilament, they may comprise electrically insulating fibres, electrically conducting fibres or a mixture of both. Yarn type and weave pattern may be selected to achieve the required electrical, tactile and physical performance properties. Where insulative materials are required, any suitable yarns that are insulative can be used such as nylon, polyester, wool, cotton or combinations thereof. Where conductive yarns are required, instead of the elastaine and stainless steel mix, other materials or combinations of two or more materials including a conductive element may be used. Yarns may be monofilament or multifilament.

The above switch embodiment relies on the action of conductive elements of the first layer 44 and second layer 45 contacting each other. However, other switching principles may be employed without departing from the concept of a woven fabric switch having at least two layers ordinarily spaced apart. For example, either of the first layer 44 or second layer 45 may be formed to include inductive coils. Such coils may be provided through an embroidering process. In this arrangement, by application of the appropriate force to cause the at least one of the first and second layer to move towards the other one of the second and first layer, respectively, an inductive coil provided in the first layer may be moved towards an inductive coil provided in the second layer thereby altering the spacing of the two inductive coils with respect to each other. The spacing of the two inductive coils (and indeed movement of the coils with respect to each other) can influence measured electrical characteristics of the coils and such measurements may be observed to establish whether the switch has been actuated.

Either of the first layer 44 or second layer 45 may be formed to provide plates of a capacitor by including a high proportion of conductive yarn. Further, optical fibres may be included in the layers to detect switching. This could be done by including in the weft of weave 41 in the vicinity of the first layer 44 one or more optical fibre for transmission of light. As an optical fibre is bent, transmission losses will vary in response to the degree of bending and the extend of losses can be used to determine whether the switch is being actuated.

It has been found that during production of the switch it is beneficial if the second layer 44 retracts by approximately 30% to cause desirable bulging of the first layer 44. Selective shrinking of particular areas of the weave may be also be obtained by printing techniques, for example the printing of areas of cellulosic fibre with caustic soda solution.

It is possible to impart a natural ‘curvature’ in the weave to help to form the blister or ‘bulge’ of first layer 44. This can be used to improve the operational characteristics of the switch in terms of performance and reliability. In the case of the warp direction, one way of doing this is by using two beams on the loom and having each beam set at different tensions. Varied tensions can achieved in the weft depending on how hard the yarn is working through each structure. Otherwise, varying weave structures can be exploited, such as plain weave/hopsack allowing the yarn to move in a variety of ways depending on how tightly woven the areas are.

As illustrated, the first layer 44 of the example switch has a cylindrical type of profile rather than a dome shape. However, this is not mandatory and the first and second layers 44, 45 of the switch region may be joined together at each periphery either by weave structure or supplemental sewing.

The design of the switch may be provided in the form of a computer programme product, optionally on a data carrier. Such computer programme product will typically, though not essentially be readable by a computer controlling weaving apparatus. In this case weave patterns may be sold as electronic data programmes.

From reading the present disclosure, other modifications will be apparent to persons skilled in the art. For example, features described as implemented in warp yarns may be implemented in weft yarns and vice versa. Such modifications may involve other features which are already known in the design, manufacture and use of woven textiles and applications thereof, which may be used instead of or in addition to features already described herein.

1. A textile switch (40) comprising a woven structure having at least one switch (43) region where the woven structure divides to exhibit a first layer (44) and a second layer (45) ordinarily spaced apart from each other, wherein on application of force at least one of the first (44) and second layers (45) is movable towards the other one of the second (45) and first layer (44), respectively, to cause actuation of the switch.

2. A textile switch in accordance with claim 1 wherein at least one of the first layer (44) and the second layer (45) include one or more electrically conductive element (47, 48) to form switch contact portions.

3. A textile switch in accordance with claim 1 wherein at least one of the first layer (44) and the second layer (45) include one or more electrically conductive element to form electrodes of a capacitor.

4. A textile switch in accordance with claim 1 wherein at least one of the first layer (44) and the second layer (45) include one or more fibre optic element.

5. A textile switch in accordance with any one or more of claims 1 to 4 wherein the first (44) and second (45) layer are ordinarily spaced apart by virtue of one of the first or second layer being of greater size than the other one of the second or first layer within the switching region (43).

6. A textile switch in accordance with any one or more of claims 1 to 5 wherein the first (44) and second layer (45) are ordinarily spaced apart by virtue of at least one of the first or second layer being fabricated to adopt a non-linear profile.

7. A method of producing a textile switch (40) of woven structure, comprising the step of:
producing a woven structure by weaving a fabric to include a region (43) where yarns are arranged to form a first layer (44) and a second layer (45), each layer being arranged to co-operate with the other layer to function as a switch when subject to application of an external force.

8. A method in accordance with claim 7 and further comprising the step of:
including the first (44) or second (45) layer resiliently extendible yarns such that on removal of the woven structure from the weaving loom the one of the first or second layer including the resiliently extendible yarns contracts by an extent greater than the other one of the first or second layer to cause the said other one of the first or second layer to buckle away from the layer including the resiliently extendible yarns.

9. A method in accordance with claim 7 or 8 and further comprising the steps of:
including in the first (44) or second (45) layer contractible yarns; and
treating of the first or second layer containing the contractible yarns to cause the contractible yarns to contact, such that the one of the first or second layer including the contractible yarns contracts by an extent greater than the other one of the first or second layer to cause the said other one of the first and second layer to buckle away from the layer that includes the contractible yarns.

10. A method in accordance with claim 7, 8 or 9 and further comprising the step of weaving at least one of the first (44) or second (45) layer to adopt a non-linear profile and to naturally bow away from the other one of the second or first layer.

11. A keypad (60) or keyboard (60) comprising at least one textile switch (40) of any one or more of claims 1 to 6.

12. An article of apparel or furniture comprising the switch, of any one or more of claims 1 to 10 or the keypad (60) or keyboard (60) of claim 11.
